(19) United States
(12) Patent Application Publication
(10) Pub. No.: US 2026/0213324 A1
(43) Pub. Date: Jul. 23, 2026

(54) BATTERY MOUNTING ASSEMBLY AND BACKUP POWER SUPPLY

(71) Applicants: WUHAN MEGMEET ELECTRICAL CO., LTD., Wuhan (CN); SHENZHEN MEGMEET ELECTRICAL CO., LTD., Shenzhen (CN)

(72) Inventors: Lun HUANG, Wuhan (CN); An CAI, Wuhan (CN); Yongzhi HUANG, Wuhan (CN); Zhongliang LIANG, Wuhan (CN); Chung Hei Albert POON, Wuhan (CN); Yu MA, Wuhan (CN)

(73) Assignees: WUHAN MEGMEET ELECTRICAL CO., LTD., Wuhan (CN); SHENZHEN MEGMEET ELECTRICAL CO., LTD., Shenzhen (CN)

(21) Appl. No.: 19/454,352

(22) Filed: Jan. 20, 2026

(30) Foreign Application Priority Data
Jan. 23, 2025 (CN) 202510112445.7

(51) Int. Cl. H01M 50/244; H01M 10/613; H01M 10/6563; H01M 50/213; H01M 50/258; H01M 50/507; H01M 50/512; H01M 50/519

(52) U.S. Cl. CPC H01M 50/244; H01M 10/613; H01M 10/6563; H01M 50/213; H01M 50/258; H01M 50/507; H01M 50/512; H01M 50/519

(57) ABSTRACT

A battery mounting assembly and a backup power supply are provided. The battery mounting assembly includes one or more parallel-connected brackets; the parallel-connected bracket includes a positive electrode bracket and a negative electrode bracket; the positive electrode bracket is arranged with two rows of first accommodating holes at intervals facing the negative electrode bracket in a first direction; where, the line connecting the center points of two adjacent first accommodating holes in different rows and the first direction form a set included angle which is greater than 0° to form a first air duct in the parallel-connected bracket; the negative electrode bracket is arranged with second accommodating holes corresponding to the first accommodating holes facing the positive electrode bracket; in the parallel-connected bracket, each first accommodating hole and corresponding second accommodating hole are arranged to set the positive electrode and the negative electrode of a cell.

### CROSS-REFERENCE TO RELATED APPLICATION

The present application claims the benefit of priority to Chinese Patent Application No. 202510112445.7, filed on Jan. 23, 2025, which is hereby incorporated by reference in its entirety.

### TECHNICAL FIELD

The embodiments of this application relate to a power supply technical field, and more particularly, to a battery mounting assembly and a backup power supply.

### TECHNICAL BACKGROUND

In the Battery Backup Unit (BBU) field, the modular design is a common form. For example, a plurality of cells form a group, a plurality of groups of cells are arranged vertically or horizontally, and the cells are fixed on a bottom bracket and a top bracket to form a pack (battery pack) assembly; The pack assembly is usually higher than the cells and is generally higher than 1U (approximately 44.45 mm or 1.75 inches), thus occupying a large space and limiting the scope of application.

### SUMMARY

The embodiments of this application provide a battery mounting assembly and a backup power supply.

In one aspect, the embodiments of this application provide a battery mounting assembly, where, the battery mounting assembly includes one or more parallel-connected brackets; the parallel-connected bracket includes a positive electrode bracket and a negative electrode bracket which is detachably connected with the positive electrode bracket; the positive electrode bracket is arranged with two rows of first accommodating holes at intervals facing the negative electrode bracket in a first direction; where, the line connecting the center points of two adjacent first accommodating holes in different rows and the first direction form a set included angle which is greater than 0° to form a first air duct in the parallel-connected bracket; the negative electrode bracket is arranged with second accommodating holes corresponding to the first accommodating holes facing the positive electrode bracket; where, in the parallel-connected bracket, each first accommodating hole and corresponding second accommodating hole are arranged to set the positive electrode and the negative electrode of a cell.

Where, a plurality of the parallel-connected brackets are arranged in a second direction; the positive electrode bracket of one parallel-connected bracket of two adjacent parallel-connected brackets is detachably connected with the negative electrode bracket of the other parallel-connected bracket of two adjacent parallel-connected brackets; the second direction is perpendicular to the first direction.

Where, the positive electrode bracket is arranged with one or more first buckling portions; the negative electrode bracket is arranged with one or more second buckling portions; in the same parallel-connected bracket, each first buckling portion is buckled with the second buckling portion to connect the positive electrode bracket and the negative electrode bracket.

Where, the positive electrode bracket is arranged with a first buckling portion on each of two opposite sides of a third direction; the negative electrode bracket is arranged with a second buckling portion on each of two opposite sides of the third direction; in the same parallel-connected bracket, the first buckling portions are corresponding to the second buckling portions respectively; where, the third direction, the second direction and the first direction are pairwise perpendicular.

Where, the positive electrode bracket is arranged with first positioning protrusions; the negative electrode bracket is arranged with first positioning grooves corresponding to the first positioning protrusions; in the same parallel-connected bracket, when the positive electrode bracket and the negative electrode bracket are connected in a clamping manner, the first positioning protrusion inserts into the first positioning groove, and the second buckling portion passes through the first positioning protrusions to buckle with the first buckling portion.

Where, the positive electrode bracket is arranged with a first positioning portion on each of two opposite sides of the first direction; the first positioning portion is arranged with a second positioning protrusion; the negative electrode bracket is arranged with a second positioning portion on each of two opposite sides of the first direction; the second positioning portion is arranged with a second positioning groove; in the same parallel-connected bracket, when the positive electrode bracket is clamped with the negative electrode bracket, the first positioning portion abuts the second positioning portion and the second positioning protrusion inserts into the second positioning groove.

Where, both the first positioning portion and the second positioning portion are arranged with positioning arc surfaces on both sides of the third direction; when the cell is installed in the battery mounting assembly, the positioning arc surfaces wrap the cell; where, the third direction, the second direction and the first direction are pairwise perpendicular.

Where, the positive electrode bracket and the negative electrode bracket are arranged with heat dissipation through-holes; the heat dissipation through-hole of the positive electrode bracket is between two adjacent first accommodating holes; the heat dissipation through-hole of the negative electrode bracket is between two adjacent second accommodating holes; heat dissipation through-holes of the positive electrode bracket and the negative electrode bracket are connected in the second direction to form a second air duct.

Where, the positive electrode bracket is arranged with one or more clamping grooves; the negative electrode bracket is arranged with one or more clamping portions corresponding to the clamping grooves; the clamping portion of the parallel-connected bracket locks in the clamping groove of the adjacent parallel-connected bracket to connect these two adjacent parallel-connected brackets.

Where, the positive electrode bracket is arranged with a clamping groove on each of both sides of the second direction; the negative electrode bracket is arranged with a clamping portion corresponding to the clamping groove on each of both sides of the second direction; the clamping grooves of one parallel-connected bracket are corresponding to the clamping portions of the adjacent parallel-connected bracket.

Where, the parallel-connected bracket also includes a battery connector; the battery connector includes positive electrode connecting tabs and negative electrode connecting tabs; the positive electrode connecting tab is arranged on the positive electrode bracket facing the negative electrode bracket; the positive electrode connecting tab is arranged with positive electrode connecting portions corresponding to the first accommodating holes of the positive electrode bracket; the negative electrode connecting tab is arranged on the negative electrode bracket facing the positive electrode bracket; the negative electrode connecting tab is arranged with negative electrode connecting portions corresponding to the second accommodating holes of the negative electrode bracket; where, in the parallel-connected bracket, each positive electrode connecting portion and corresponding negative electrode connecting portion are arranged to set the positive electrode and the negative electrode of the cell. The positive electrode connecting tab connects the positive electrodes of all cells and the negative electrode connecting tab connects the negative electrodes of all cells.

Where, the battery mounting assembly also includes a positioning plate; the positioning plate is connected to one side of the plurality of the parallel-connected brackets and extends from one end to the other end of the plurality of the parallel-connected brackets in the second direction.

Where, each positive electrode bracket and/or each negative electrode bracket are arranged with a positioning buckle in a protruding manner in the third direction; the positioning plate is arranged with a positioning hole for each positioning buckle; each positioning buckle is embedded in the corresponding positioning hole; where, the third direction, the second direction and the first direction are pairwise perpendicular.

Where, the battery mounting assembly also includes a circuit board; the circuit board is connected to the other side of the plurality of the parallel-connected brackets and extends from one end to the other end of the plurality of the parallel-connected brackets in the second direction; the circuit board connects each positive electrode connecting tab and/or each negative electrode connecting tab.

Where, each positive electrode connecting tab and/or each negative electrode bracket are arranged with first connecting portions in a protruding manner in the opposite direction of the third direction; the circuit board is arranged with a first connecting hole for each first connecting portion; each first connecting portion is embedded in the corresponding first connecting hole; where, the third direction, the second direction and the first direction are pairwise perpendicular; and/or, each positive electrode bracket and/or each negative electrode bracket are arranged with second connecting portions in a protruding manner in the opposite direction of the third direction; the circuit board is arranged with a second connecting hole for each second connecting portion; each second connecting portion is embedded in the corresponding second connecting hole.

Where, the battery mounting assembly also includes a fan mounting bracket; the fan mounting bracket is connected to one end of the plurality of the parallel-connected brackets; when the plurality of the parallel-connected brackets are arranged with the cells, heat dissipation gaps are formed among cells in an extension and communication manner in the second direction; the fan mounting bracket is for mounting heat dissipation fans for corresponding heat dissipation gaps.

Where, the battery mounting assembly also includes a case; the case is arranged with an accommodating cavity inside; the plurality of the parallel-connected brackets are arranged in the accommodating cavity and are not higher than a set height in the first direction.

In another aspect, the embodiments provide a backup power supply; the backup power supply includes a battery mounting assembly and a plurality of cells; the plurality of the cells are connected to the battery mounting assembly; where, the battery mounting assembly is as defined in any one of above mentioned claims.

### BRIEF DESCRIPTION OF DRAWINGS

FIG. 1 illustrates an exploded drawing of an embodiment of the backup power supply in the application;

FIG. 2 illustrates structural diagrams of an embodiment of the positive electrode bracket and the negative electrode bracket of the parallel-connected bracket of the backup power supply in FIG. 1;

FIG. 3 illustrates structural diagrams of the positive electrode bracket and the negative electrode bracket in FIG. 2 in another viewing angle;

FIG. 4 illustrates a structural diagram of the positive electrode bracket in FIG. 2 in another viewing angle;

FIG. 5 illustrates a structural diagram of an embodiment of the battery connector of the parallel-connected bracket of the backup power supply in FIG. 1.

### DETAILED DESCRIPTION

The technical schemes in the embodiments of the application will be described below with reference to the accompanying drawings. Obviously, the described embodiments are merely part of the present application, not all of them. All other embodiments obtained by persons skilled in the art without putting in creative efforts based on the embodiments of the application shall fall within the protection scope of the application.

In this application, the terms “first,” “second,” and “third” are only for description and may not be understood as indicating or implying relative importance or implying the number of technical features. Therefore, the “first,” “second,” and “third” features can explicitly or implicitly include one or more of the features. In the description of this application, the term “a plurality of” means two or more, unless otherwise specified. All directional indications (such as up, down, left, right, front, rear, etc.) in the embodiments of the application are only for explaining the relative positional relationship and movement state between/among components in a specific posture (as shown in the accompanying drawings). If the specific posture changes, the directional indication shall change accordingly. In addition, the terms “include,” “comprise” and any other variants are intended to cover non-exclusive inclusion. For example, a series of steps or units included in a process, a method, a system, a product or a device are not limited to the listed steps or units, but in some embodiments, may include steps or units that are not listed, or may include other steps or units inherent to the process, the method, the product or the device.

The term “embodiment” in this application means that specific features, structures or characteristics described with reference to the embodiments may be included in one or more embodiments in this application. The term “embodiment” in different positions in the specifications is not necessarily the same embodiment, nor an independent or alternative embodiment that is exclusive with other embodiments. Persons skilled in the art explicitly and implicitly understand that the embodiments in this application may be combined with other embodiments.

The beneficial effects of the application are as follows: different from the related art, the parallel-connected bracket of the battery mounting assembly provided in this application includes the positive electrode bracket and the negative electrode bracket which is detachably connected with the positive electrode bracket; the positive electrode bracket is arranged with two rows of the first accommodating holes at intervals facing the negative electrode bracket in the first direction, and the line connecting the center points of two adjacent first accommodating holes in different rows and the first direction form the set included angle which is greater than 0° to form the first air duct in the parallel-connected bracket; the negative electrode bracket is arranged with the second accommodating holes corresponding to the first accommodating holes facing the positive electrode bracket; in the parallel-connected bracket, each first accommodating hole and corresponding second accommodating hole are arranged to set the positive electrode and the negative electrode of a cell. Thereby, in the first direction, i.e., the height direction, different rows of the cells are arranged in a staggered manner with a certain height difference so as to arrange a greater number of cells more compactly within a limited space, thus effectively reducing the overall height of the product. Therefore, the application scope of this product is wider, i.e., electronic devices with limited spatial structure, especially any reasonable electronic device with a standard cabinet unit height of 1U (approximately 44.45 mm or 1.75 inches), such as server cabinets, power distribution cabinets, and communication devices. In addition, because the negative electrode bracket is detachable, an individual cell of the battery module can be maintained or replaced more conveniently. The cells are arranged at a certain inclined angle to improve the cooling effect, reduce the mechanical stress, or simplify the manufacturing process. Cells which are not vertically arranged are also conducive to air circulation or heat sink arrangement, thus improving the heat dissipation performance of the entire battery module. The detachable connection design provides the possibility of flexible configuration, enabling adjustment of the number and arrangement mode of cells according to different application requirements.

A detailed explanation of this application will be provided with reference to the accompanying drawings and embodiments as follows.

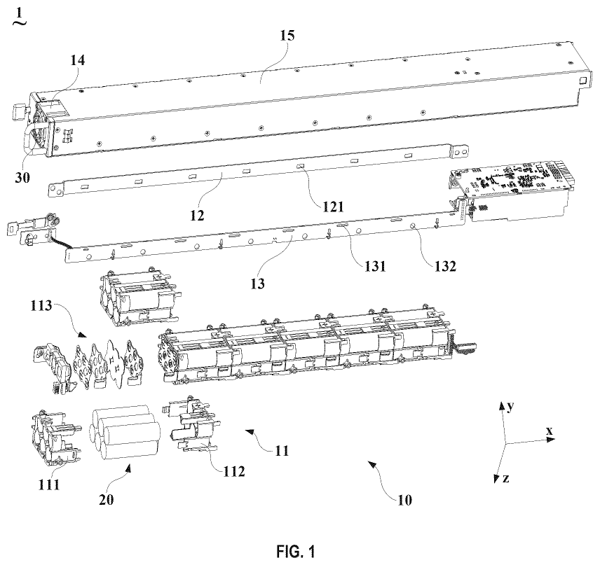

Referring to FIG. 1, FIG. 1 illustrates an exploded drawing of an embodiment of the backup power supply in the application.

In the embodiment, the backup power supply 1 includes a battery mounting assembly 10 and a plurality of cells 20; the plurality of the cells 20 are connected to the battery mounting assembly 10.

It is worth noting that the backup power supply 1 may be a Battery Backup Unit (BBU) field, a functional component for providing emergency power support, to mainly prevent data loss and service interruption caused by failure of mains power. In the event of a power interruption, the BBU can provide power supply in a short term for the system to ensure continuous operation and safe shutdown of the key devices, thereby protecting the integrity of data and the system.

In the event of a power interruption, the BBU may automatically take over the power supply task, with a typical power supply duration within a few minutes. It may be applied to core Information Technology (IT) equipment such as servers, data centers and communication base stations, to ensure normal data and system operation in case of power failure. The BBU is usually combined with devices such as Uninterruptible Power Supply (UPS) and diesel generators to form a multi-level backup power supply scheme, so as to meet the demand of different time and power; it may be embedded in a server cabinet in a distributed manner and flexibly configured as required.

Where, the plurality of the cells 20 constitute a core energy storage unit of the backup power supply 1 to provide the required power support. The battery mounting assembly 10 provides a physical support and a fixing structure for the cells 20; the plurality of the cells 20 are connected to the battery mounting assembly 10 in a specific manner to form a modular pack assembly, i.e., the backup power supply 1.

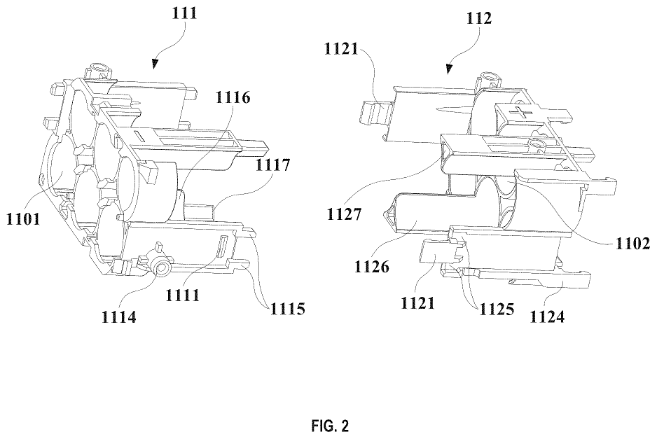

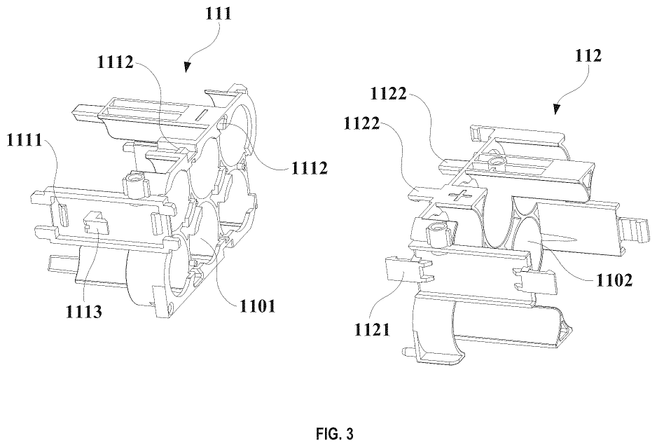

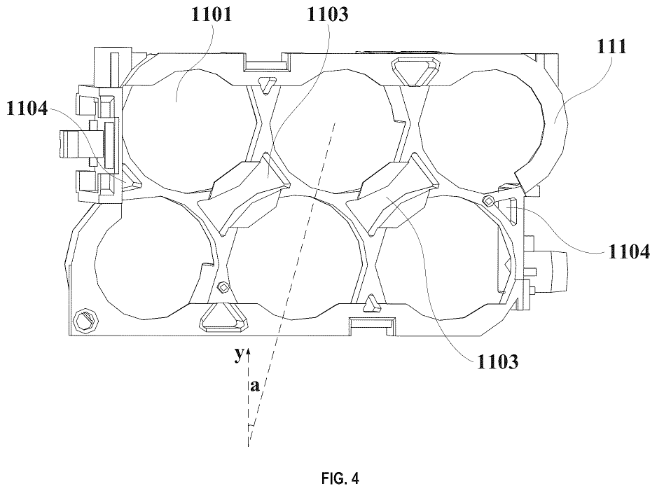

In some embodiments, referring to FIG. 2-FIG. 4, where, FIG. 2 illustrates structural diagrams of an embodiment of the positive electrode bracket and the negative electrode bracket of the parallel-connected bracket of the backup power supply in FIG. 1; FIG. 3 illustrates structural diagrams of the positive electrode bracket and the negative electrode bracket in FIG. 2 in another viewing angle; FIG. 4 illustrates a structural diagram of the positive electrode bracket in FIG. 2 in another viewing angle. In the present embodiment, the battery mounting assembly may include one or more parallel-connected brackets 11.

Where, the battery mounting assembly 10 provided in the application is applied to the backup power supply 1, such as server BBU, and is used to arrange the plurality of the cells 20 in a specific manner so as to form a modular pack assembly. In other embodiments, the battery mounting assembly 10 may also be applied to the backup power supplies of communication devices, medical devices or any other reasonable electronic devices.

In some embodiments, each parallel-connected bracket 11 includes two parts, i.e., a positive electrode bracket 111 and a negative electrode bracket 112 which is detachably connected with the positive electrode bracket 111; thereby, in order to maintain or replace a battery, the negative electrode bracket 112 can be conveniently detached for the purpose of accessing to or removing the cell 20.

The positive electrode bracket 111 is arranged with two rows of first accommodating holes 1101 and the corresponding negative electrode bracket 112 is arranged with corresponding second accommodating holes 1102. Each first accommodating hole 1101 and corresponding second accommodating hole 1102 are arranged to set the positive electrode and the negative electrode of a cell 20. This means that the cell 20 will be placed between the two brackets. The positive electrodes and the negative electrodes of the cells are respectively arranged in their respective accommodating holes.

Where, the line connecting the center points of two adjacent first accommodating holes 1101 in different rows of the positive electrode bracket 111 and the first direction y form a set included angle α to form a first air duct 1103 in the parallel-connected bracket 11 for providing heat dissipation paths for the cells 20.

It is worth noting that the included angle in the application means the minimum positive angle formed by the intersection of two straight lines (or vectors), and is usually denoted as ∠α. The range of the included angle ∠α between two straight lines is 0°≤∠α≤90°.

Where, the set included angle α refers to the included angle between the straight line of the line connecting the center points of two adjacent first accommodating holes 1101 in different rows of the positive electrode bracket 111 and the straight line of the first direction y. The set included angle α is greater than 0°, i.e., the cells 20 are not arranged at a right angle, but at a certain inclination angle. In addition, in the first direction y, for example, the height direction, different rows of the cells are arranged in a staggered manner with a certain height difference and are not parallel to the first direction y.

It is to be understood that the second accommodating holes 1102 of the negative electrode bracket 112 also conform to the specific features of the first accommodating holes 1101, i.e., the line connecting the center points of two adjacent second accommodating holes 1102 in different rows and the first direction y form a set included angle α.

In above scheme, different rows of the cells 20 are arranged in the battery mounting assembly 10 in a staggered manner with a certain height difference in the first direction y so as to arrange a greater number of the cells 20 more compactly within a limited space, and effectively reduce the overall height of the product. Therefore, the application scope of this product is wider, i.e., electronic devices with limited spatial structures, especially any reasonable electronic device with a standard cabinet unit height of 1U, such as server cabinets, power distribution cabinets, and communication devices. In addition, because the negative electrode bracket 112 is detachable, the maintenance or replacement of an individual cell 20 of the battery module is more convenient. The cells 20 are arranged at a certain inclined angle to improve the cooling effect, reduce mechanical stress, or simplify the manufacturing process. The cells 20 which are not vertically arranged are also conducive to air circulation or heat sink arrangement, thus improving the heat dissipation performance of the entire battery module. The detachable connection design provides the possibility of flexible configuration, enabling adjustment of the number and arrangement manner of the cells 20 according to different application requirements. The mounting assembly of the cells 20 is particularly suitable for data centers, communication base stations, industrial automation systems, medical device vehicles, energy storage systems and other application scenarios that require efficient management and arrangement of the plurality of cells. This product not only supports large-scale production and automatic assembly lines, but also facilitates subsequent product services and supports.

It is worth noting that electronic devices with a standard cabinet unit height of 1U are widely applied in data centers, communication base stations, server rooms and other scenarios. Such devices are generally designed to be compact to maximize space utilization, and comply with industry standards to facilitate installation and maintenance. The following devices are several common types of electronic devices with a standard cabinet unit height of 1U:

### 1U. Servers

1U server: It is one of the most common 1U devices, and is suitable for environments where the 1U devices are arranged densely. 1U servers can provide powerful computing capability within a limited space and are commonly used for World Wide Web (Web) hosting, database services, and other enterprise-level applications.

### 2. Network Devices

Switch: A 1U network switch is a core component of data centers and enterprise networks, provides multi-port connections and supports high-speed data transmission.
Router: Some small to medium-sized enterprise routers are also 1U type, and are conducive to being integrated into existing network infrastructures.

### 3. Storage Devices

Network attached storage: A 1U network attached storage device provides an economical and efficient solution for file sharing and backup, and is suitable for small and medium-sized enterprises and remote offices.
Storage area network controller: Although the entire storage area network system may take up a larger space, its controller is often designed in the 1U specification.

### 4. Power Management Devices

UPS: A 1U UPS can provide power supply in the short term in the event of a mains power interruption to ensure that the critical devices will not be powered off immediately.
Power distribution unit: A 1U power distribution unit is designed for distributing the power to a plurality of devices, with multi-functional monitoring and intelligent power management supporting functions.

### 5. Security and Monitoring Devices

Firewall: Some network security devices, such as firewalls, are designed in the 1U specification for easy installation in standard cabinets.
Video monitoring server: It is for centralized management and storage of data of the video monitoring system.

### 6. Communication Devices

Communication module: Include various communication protocol converters, modems, etc. for interconnection and intercommunication between different communication networks.
Wireless communication device: For example, radio base station controllers for public security and emergency response may also be designed in the 1U specification.

### 7. Audio/Video Processing Devices

Audio/video (AV) matrix switch: It is for selecting a router of audio and video signals, and is commonly used in fields such as broadcasting and conference systems.
Encoder/decoder: They are for encoding and decoding of media streams, and play an important role in media stream distribution.

### 8. Test and Measurement Devices

Test device: Some portable or laboratory test instruments are also designed in the 1U specification. Therefore, they are conveniently carried and installed in cabinets for testing on site.

### 9. Other special-purpose devices

Industrial control computer: An embedded computer in an automated control system is sometimes designed in the 1U specification.
Medical device interface module: It is for connecting and integrating data transmission between hospital information systems and other medical devices.

To sum up, 1U electronic devices have become an indispensable part of data centers and various professional environments due to compact design and standardized installation. They not only save valuable physical spaces, but also improve the scalability and maintainability of systems. With the advancement of technologies, more and more functions are integrated into smaller spaces, expanding the application range of 1U devices.

In some embodiments, the set included angle α between the line connecting the center points of two adjacent first accommodating holes 1101 in different rows and the first direction y ranges from 0° to 45°, and preferably ranges from 1° to 30°. Therefore, when cells 20 are in the standard specification, the maximum distance between two rows of the cells 20 in the first direction y, i.e., the height of two rows of the cells 20, can be controlled within 37.9 mm. Thereby, the overall height of the modular pack assembly with cells 20 mounted in the plurality of parallel-connected brackets 11 is less than 1U. In addition, there are gap air ducts among cells 20 in the pack assembly, facilitating air circulation and heat dissipation.

In some embodiments, the plurality of the parallel-connected brackets 11 are arranged in the second direction x; the positive electrode bracket 111 of one parallel-connected bracket 11 of two adjacent parallel-connected brackets 11 is detachably connected with the negative electrode bracket 112 of the other parallel-connected bracket 11 of two adjacent parallel-connected brackets 11 to ensure that a series or parallel circuit can be formed among the cells 20. In addition, a flexible electrical connection scheme is provided.

Where, the second direction x is perpendicular to the first direction y, i.e., the plurality of the parallel-connected brackets 11 are arranged in two perpendicular directions to form a grid structure. Thereby, the battery module may be arranged with a large number of the cells 20 in a compact manner on a plane, improving the space utilization.

Moreover, adjacent parallel-connected brackets 11 are connected by detachable connection between the positive electrode bracket 111 and the negative electrode bracket 112, which not only simplifies the electrical connection between the cells 20, but also facilitates the maintenance and replacement of the cells 20.

It is to be understood that the plurality of the cells 20 arranged in one parallel-connected bracket 11 form a group or a parallel unit. The cells 20 in a group have the same positive and negative electrode directions, but have different positive and negative electrode directions with that of cells of another adjacent the parallel-connected bracket 11 in front or rear of the group. The cells 20 are arranged side by side. The adjacent parallel units are connected end to end and are connected in series in a cascade manner by extending in the axial direction of the cells 20, i.e., the second direction x.

Where, the cells 20 in each parallel unit are arranged in a staggered manner with a certain height difference and are fixed on the positive electrode bracket 111 and the negative electrode bracket 112; the positive electrode bracket 111 is detachably connected with the negative electrode bracket 112; two parallel units are detachably connected to form an integral structure.

In some embodiments, in the parallel-connected bracket 11, the positive electrode bracket 111 and the negative electrode bracket 112 are connected via buckling portions. Where, the positive electrode bracket 111 is arranged with one or more first buckling portions 1111, and the negative electrode bracket 112 is arranged with one or more second buckling portions 1121 to match with the first buckling portions 1111 of the positive electrode bracket 111. Each first buckling portion 1111 in the same parallel-connected bracket 11 is arranged to accurately match with the second buckling portion 1121, so as to ensure stable connection between the positive electrode bracket 111 and the negative electrode bracket 112, and to facilitate dismantling and maintenance.

In some embodiments, the positive electrode bracket 111 is arranged with a first buckling portion 1111 on each of two opposite sides of a third direction z; the negative electrode bracket 112 is arranged with a second buckling portion 1121 on each of two opposite sides of the third direction z; in the same parallel-connected bracket 11, the first buckling portions 1111 are corresponding to the second buckling portions 1121 of the negative electrode bracket 112 respectively. The arrangement can ensure that each first buckling portion 1111 can be tightly buckled with the corresponding second buckling portion 1121 to form a stable connection, thereby achieving the connection between the positive electrode bracket 111 and the negative electrode bracket 112 in the same parallel-connected bracket 11. In addition, clamping force is formed on the opposite sides of each parallel-connected bracket 11, further stabilizing the connection between the positive electrode bracket 111 and the negative electrode bracket 112, simplifying the assembly process, enabling quick assembly and disassembly, and facilitating the maintenance and replacement of the cells 20.

Where, the third direction z, the second direction x and the first direction y are pairwise perpendicular.

It is to be understood that the clamping design enables quick connection or detachment of the positive electrode bracket 111 and the negative electrode bracket 112 for shortening assembly time and reducing assembly complexity. The design of the buckling portions ensures a reliable mechanical connection between the positive electrode bracket 111 and the negative electrode bracket 112, even in vibration or impact conditions. This connection mode supports modular battery assembly and realizes the flexible adjustment of the dimension and the shape of the battery module according to demand. To maintain or replace a certain cell 20, the target cell 20 may be easily removed or replaced simply by releasing the corresponding buckling portion, without affecting other components. The buckling portion is designed to adapt to different sizes and specifications, and is suitable for multiple types of the cells 20, thereby increasing the universality and flexibility of the system. The mounting assembly of the cells 20 with clamping structures is characterized by quick assembly, stable connection and easy maintenance, and significantly improves the design and application efficiency of the battery module.

In some embodiments, the number of the first buckling portions 1111 in the positive electrode bracket 111 may be 2, 3, 6, or any reasonable number. The number of the second buckling portions 1121 may also be 2, 3, 6, or any reasonable number correspondingly. The structures of the different first buckling portions 1111 may be the same or different. Correspondingly, the structures of the second buckling portions 1121 may also be the same or different. In some embodiments, the buckling portions may be in a buckle form, and/or one is a partially triangular prism, a partially cylinder, a partially elliptical cylinder and a cylinder with any reasonable shape, and the other one is a matched groove or blind hole.

In some embodiments, the positive electrode bracket 111 is arranged with first positioning protrusions 1115; the negative electrode bracket 112 is arranged with first positioning grooves 1125 corresponding to the first positioning protrusions 1115 to ensure accurate alignment of the positive electrode bracket 111 and the negative electrode bracket 112. In the same parallel-connected bracket 11, when the positive electrode bracket 111 and the negative electrode bracket 112 are connected in a clamping manner, the first positioning protrusion 1115 inserts into the first positioning groove 1125 to ensure accurate alignment of the two in the horizontal direction. In addition, the second buckling portion 1121 passes through the first positioning protrusions 1115 to buckle with the first buckling portion 1111 to ensure stable connection in the vertical direction.

It is to be understood that the design of the first positioning protrusion 1115 and the first positioning groove 1125 ensures the accurate alignment of the positive electrode bracket 111 and the negative electrode bracket 112, avoiding the risk of poor contact or short circuit caused by misalignment. The positioning connection between the first positioning protrusion 1115 and the first positioning groove 1125 and the buckling connection between the first buckling portion 1111 and the second buckling portion 1121 realize multi-dimensional stable connection, reducing the possibility of looseness or detachment. The design of positioning and buckling realizes quick connection and detachment of the positive electrode bracket 111 and the negative electrode bracket 112, significantly simplifying the assembly and maintenance process. The clear positioning structure reduces possible errors in the assembly process, improving production efficiency and product quality. Accurate alignment and stable connections are conducive to good electrical contact, reduce resistance losses, and improve overall system performance.

In some embodiments, the positive electrode bracket 111 is arranged with a first positioning portion 1116 on each of two opposite sides of the first direction y; the negative electrode bracket 112 is arranged with a second positioning portion 1126 on each of two opposite sides of the first direction y to correspond to the first positioning portion 1116 in the positive electrode bracket 111, realizing the accurate alignment. The first positioning portion 1116 is arranged with a second positioning protrusion 1117. The second positioning portion 1126 is arranged with a second positioning groove 1127 to match with the second positioning protrusion 1117 in the positive electrode bracket 111 for the purpose of accommodating and fixing the second positioning protrusion 1117. In the same parallel-connected bracket 11, when the positive electrode bracket 111 is clamped with the negative electrode bracket 112, the first positioning portion 1116 abuts the second positioning portion 1126 and the second positioning protrusion 1117 inserts into the second positioning groove 1127 to ensure the accurate alignment of the positive electrode bracket 111 and the negative electrode bracket 112 in the horizontal direction. In addition, additional mechanical locking function is provided to prevent accidental loosening.

It is to be understood that the design of the first positioning portion 1116 and the second positioning portion 1126 ensures the accurate alignment of the positive electrode bracket 111 and the negative electrode bracket 112, avoiding the risk of poor contact or short circuit caused by misalignment. In addition, because the positioning portions are arranged on both sides of the positive electrode bracket 111 and the negative electrode bracket 112, multi-point contact is realized in connection, improving the overall stability of the connection. The positioning connection of the second positioning protrusion 1117 and the second positioning groove 1127 and the abutting connection of the first positioning portion 1116 and the second positioning portion 1126 realize multi-dimensional stable connection, reducing the possibility of looseness or detachment. The design of positioning and clamping realizes quick connection and detachment of the positive electrode bracket 111 and the negative electrode bracket 112, significantly simplifying the assembly and maintenance process. The clear positioning structure reduces possible errors in the assembly process, improving production efficiency and product quality. Accurate alignment and stable connections are conducive to good electrical contact, reduce resistance losses, and improve overall system performance.

Further, in some embodiments, the first positioning portion 1116 in the positive electrode bracket 111 is arranged with positioning arc surfaces (not shown in the drawing) on both sides of the third direction z; the second positioning portion 1126 of the negative electrode bracket 112 is also arranged with positioning arc surfaces on both sides of the third direction z. When the cell is installed in the battery mounting assembly, the positioning arc surfaces wrap the cell to provide additional fixation and support.

It is to be understood that in the same parallel-connected bracket 11, when the positive electrode bracket 111 is clamped with the negative electrode bracket 112, the first positioning portion 1116 abuts the second positioning portion 1126, the second positioning protrusion 1117 inserts into the second positioning groove 1127, and the positioning arc surfaces wrap the cell to ensure stable mounting of the cell in the mounting assembly. Because the positioning arc surfaces are arranged on both sides of the first positioning portion 1116 and the second positioning portion 1126, the cell is installed in a multi-point contacting and wrapping manner, improving the fixation effect of cells and providing better mechanical protection. The design of positioning arc surfaces can significantly improve the fixation effect of cells and reliability of connection in the battery mounting assembly. In addition, the tight contact between the positioning arc surfaces and the cells is conducive to heat conduction. Combined with a proper heat dissipation design, the heat dissipation performance of the cells can be effectively improved.

In some embodiments, the positive electrode bracket 111 and the negative electrode bracket 112 are arranged with heat dissipation through-holes (not shown in the drawing); where, the heat dissipation through-hole of the positive electrode bracket 111 is between two adjacent first accommodating holes 1101 to promote the transfer of heat from the cells to air. The heat dissipation through-hole of the negative electrode bracket 112 is between two adjacent second accommodating holes 1102 to promote the transfer of heat from the cells to air similarly. The heat dissipation through-holes of the positive electrode bracket 111 and the negative electrode bracket 112 are aligned and connected in the second direction x to form a continuous second air duct 1104 to ensure that airflow can smoothly pass through the entire bracket structure from one side to the other side and take away the heat generated by the cells, thus achieving a highly efficient heat dissipation effect.

It is to be understood that the design of the heat dissipation through-holes can quickly transfer heat from the surface of the cells to the bracket and take away the heat by external air via the second air duct 1104, avoiding local overheating. The heat dissipation through-holes are arranged among adjacent accommodating holes to ensure uniform cooling of each cell to prevent problems caused by poor heat dissipation in certain areas. The heat dissipation through-holes may not weaken the overall structural strength of the bracket. On the contrary, the rational design of the heat dissipation through-holes can further enhance the rigidity of the bracket, such as adding supporting reinforcements. The heat dissipation through-holes are generally made by stamping or molding. The process realizes the batch production and quality control, thereby reducing the manufacturing costs. The effective heat dissipation design prolongs the service life of the cells and other components, reduces the failure rate caused by overheating, and improves the reliability and security of the entire system. The heat dissipation through-holes provide a fast path for heat conduction. The second air duct 1104 optimizes the airflow path, thereby improving the heat dissipation efficiency.

In some embodiments, the positive electrode bracket 111 is arranged with one or more clamping grooves 1112; the negative electrode bracket 112 is arranged with one or more clamping portions 1122 corresponding to the clamping grooves 1112 to ensure stable connection of two adjacent parallel-connected brackets 11. In the same parallel-connected bracket 11, the clamping portions 1122 of the negative electrode bracket 112 may be clamped in the clamping grooves 1112 of the adjacent parallel-connected bracket 11 to connect two adjacent parallel-connected brackets 11, realizing the quick connection of the plurality of the parallel-connected brackets 11 by simple insertion operation.

It is to be understood that the design of the clamping grooves 1112 and the clamping portions 1122 realizes the quick connection or detachment of two adjacent parallel-connected brackets 11, significantly simplifying the assembly and maintenance process. The cooperation of the clamping grooves 1112 and the clamping portions 1122 realizes the multi-point contact, reducing the possibility of looseness or detachment and ensuring the stable and reliable connection. This design allows flexible expansion of the battery system according to demand. The additional parallel-connected bracket 11 can be easily integrated with the existing structure, improving the scalability of the system. The clear position of clamping grooves 1112 and clamping portions 1122 reduces possible errors in the assembly process, improving production efficiency and product quality. The clamping grooves 1112 and the clamping portions 1122 provide a simple and effective solution for connection, and ensure the quick and stable connection of the plurality of the parallel-connected brackets 11. The clamping grooves 1112 and the clamping portions 1122 are suitable for various application scenarios and meet various technical requirements.

Further, in some embodiments, the positive electrode bracket 111 of the parallel-connected bracket 11 is arranged with a clamping groove 1112 on each of both sides of the second direction x; the negative electrode bracket 112 is arranged with a clamping portion 1122 corresponding to the clamping groove 1112 of the positive electrode bracket 111 in the second direction x. The clamping grooves 1112 of the parallel-connected bracket 11 are corresponding to clamping portions 1122 of the adjacent parallel-connected bracket 11, i.e., the clamping portion 1122 may be closely matched with the clamping groove 1112 of the positive electrode bracket 111, to ensure stable connection of two adjacent parallel-connected brackets 11.

Where, the clamping portion 1122 of the negative electrode bracket 112 of the parallel-connected bracket 11 is clamped in the clamping groove 1112 of the positive electrode bracket 111 of the adjacent parallel-connected bracket 11 to realize the connection of two adjacent parallel-connected brackets 11, ensuring the firmness of mechanical connections. In addition, clamping force is formed on the opposite sides of each parallel-connected bracket 11, further stabilizing the connection of two adjacent parallel-connected brackets 11. Moreover, the detachment design facilitates the maintenance and replacement of the cells 20.

It is to be understood that the design of the clamping grooves 1112 and the clamping portions 1122 quickly connects or detaches the positive electrode bracket 111 and the negative electrode bracket 112 for shortening assembly time and reducing assembly complexity, thereby improving the production efficiency. The closely matched clamping grooves 1112 and clamping portions 1122 provide a reliable mechanical connection, even in vibration or impact conditions, reducing the risks of looseness. The clamping grooves 1112 and the clamping portions 1122 are designed to adapt to different dimensions and specifications and are suitable for cells 20 with various types, improving the universality and flexibility of the system.

Where, the parallel-connected bracket 11 formed by the positive electrode bracket 111 and the negative electrode bracket 112 may be cuboid. In some embodiments, the first buckling portion 1111 and the second buckling portion 1121 may be arranged on two side surfaces of the parallel-connected bracket 11; the clamping groove 1112 and the clamping portion 1122 may be arranged on another two side surfaces of the parallel-connected bracket 11.

In some embodiments, the number of the clamping grooves 1112 of the positive electrode bracket 111 may be 2, 4, 6 or any reasonable number. The number of clamping portions 1122 may also be 2, 4, 6, or any reasonable number correspondingly. The structures of the different clamping portions 1122 may be the same or different. In some embodiments, the structure may be a triangular prism, a partially cylinder, a partially elliptical cylinder and a cylinder with any reasonable shape. Corresponding clamping grooves 1112 are grooves or blind holes matched with the clamping portions 1122. In addition, the clamping portions 1122 and the clamping grooves 1112 may also be in a buckle form. The application imposes no limitation thereon.

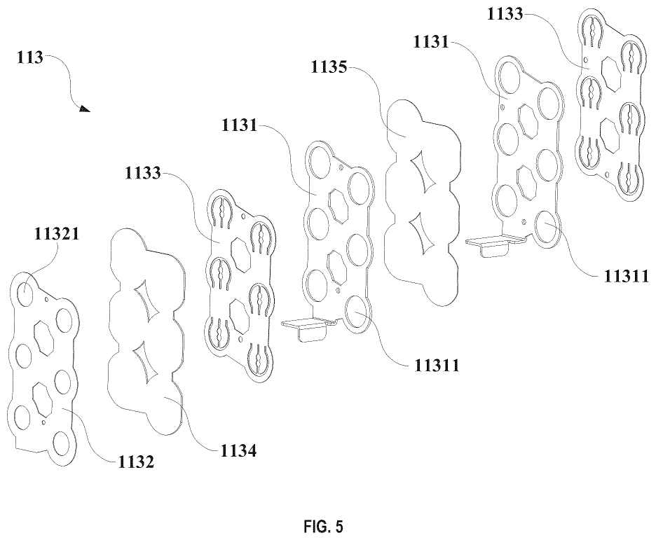

Continuously referring to FIG. 5, FIG. 5 illustrates a structural diagram of an embodiment of the battery connector of the parallel-connected bracket of the backup power supply in FIG. 1.

In some embodiments, the parallel-connected bracket 11 also includes a battery connector 113; the battery connector 113 includes positive electrode connecting tabs 1131 and negative electrode connecting tabs 1132; the positive electrode connecting tab 1131 is arranged on the positive electrode bracket 111 facing the negative electrode bracket 112 and is corresponding to each first accommodating hole 1101 of the positive electrode bracket 111; the positive electrode connecting tab 1131 is arranged with positive electrode connecting portions 11311 to connect the positive electrode of each cell 20.

The negative electrode connecting tab 1132 is arranged on the negative electrode bracket 112 facing the positive electrode bracket 111 and is corresponding to each second accommodating hole 1102 of the negative electrode bracket 112. The negative electrode connecting tab 1132 is arranged with negative electrode connecting portions 11321 to connect the negative electrode of each cell 20.

It is to be understood that in the parallel-connected bracket 11, each positive electrode connecting portion 11311 and corresponding negative electrode connecting portion 11321 are arranged to set the positive electrode and the negative electrode of a cell 20. In this manner, the positive electrode connecting tab 1131 can connect positive electrodes of all cells 20 and the negative electrode connecting tab 1132 can connect negative electrodes of all cells 20 to form a uniform electrical connection network.

Where, the plurality of cells 20 form a group; the cells 20 in a group have the same positive electrode and negative electrode directions; the cells 20 in the group are connected to form a parallel-connected group by connecting the positive electrodes and the negative electrodes of the cells via the positive electrode connecting tab 1131 and the negative electrode connecting tab 1132; the directions of the positive electrodes and the negative electrodes of a plurality of adjacent cells 20 are consistent respectively, but are opposite to the directions of the positive electrodes and the negative electrodes of cells 20 in the front group. The cells 20 are arranged side by side. Adjacent parallel-connected groups are connected by the battery connector 113 which connects the positive electrode and the negative electrode to realize the cascade series connection.

The dedicated positive electrode connecting tab 1131 and negative electrode connecting tab 1132 can efficiently connect the positive and negative electrodes of all cells 20, reducing the complexity and time in the traditional connection. The design of the connecting tabs provides a more stable electrical connection, reducing the risks of poor contact or looseness and improving the reliability of the entire system. A certain cell 20 can be replaced or maintained simply by disconnecting corresponding connecting tab, without affecting other cells 20. The connection mode can be adjusted according to actual needs (such as series connection, parallel connection or hybrid connection) to meet the voltage and current requirements in different application scenarios. The separating design of the positive electrode connecting tab 1131 and the negative electrode connecting tab 1132 is conducive to preventing short circuits, thereby enhancing the security performance of the system. Properly arranged connecting tabs can help improve air circulation or coolant flow paths, which is conducive to the heat management of the entire battery module. The mounting assembly of cells 20 with the battery connector 113 provides simplified electrical connection, high reliability and easy maintenance, significantly improving the design and application efficiency of the battery module.

In some embodiments, the battery connector 113 includes positive electrode gaskets 1133 and negative electrode gaskets 1134; the positive electrode gasket 1133 is arranged on the positive electrode connecting tab 1131 facing the negative electrode connecting tab 1132 to connect the positive electrodes of all cells 20; the negative electrode gasket 1134 is arranged on the negative electrode connecting tab 1132 facing the positive electrode connecting tab 1131 to connect the negative electrodes of all cells 20 so as to realize better conductive connection between the cell 20 and the positive electrode connecting tab 1131 and between the cell 20 and the negative electrode connecting tab 1132 by utilizing the positive electrode gasket 1133 and negative electrode gasket 1134. The positive electrode gasket 1133 and negative electrode gasket 1134 reliably connect the positive electrodes and the negative electrodes of all cells 20 in the groups.

In some embodiments, the battery connector 113 also includes a cascade gasket 1135. The cascade gasket 1135 is arranged between the positive electrode connecting tab 1131 of a parallel-connected bracket 11 and the negative electrode connecting tab 1132 of another adjacent parallel-connected bracket 11 to connect the positive electrode and the negative electrode of two adjacent cells 20, realizing cascade series connection.

In some embodiments, the battery mounting assembly 10 also includes a positioning plate 12; the positioning plate 12 is connected to one side of the plurality of the parallel-connected brackets 11 and extends from one end to the other end of the plurality of the parallel-connected brackets 11 in the second direction x to ensure accurate position of the parallel-connected bracket 11 and other components in assembly process, improving the assembly accuracy and efficiency.

Further, in some embodiments, each positive electrode bracket 111 and/or each negative electrode bracket 112 are arranged with a positioning buckle 1113 in a protruding manner in the third direction z. The design of the positioning buckle 1113 can ensure the accurate alignment of the positive electrode bracket 111 and the negative electrode bracket 112 in assembly process to prevent the deviation. The positioning plate 12 is arranged with a positioning hole 121 for each positioning buckle 1113. Each positioning buckle 1113 is embedded in the corresponding positioning hole 121 to ensure the stable fixation of the positioning plate 12 on the parallel-connected bracket 11. The design provides additional mechanical support and accurate positioning, and enhances the structural stability of the entire system, particularly in vibration or impact conditions. The matching of the positioning buckle 1113 and the positioning hole 121 also ensures the accurate positioning of all components in assembly process, reducing errors and improving the assembly efficiency and quality.

In some embodiments, the battery mounting assembly 10 also includes a circuit board 13; the circuit board 13 is connected to the other side of the plurality of the parallel-connected brackets 11 and extends from one end to the other end of the plurality of the parallel-connected brackets 11 in the second direction x to cover the side of the entire battery modular and provide electrical connection and signal transmission functions.

Where, the circuit board 13 is connected with the positive electrode connecting tab 1131 and negative electrode connecting tab 1132 via pin insertion, welding or other connection modes to ensure effective connection of the positive electrodes and/or the negative electrodes of all cells 20 to the circuit board 13. Thereby, the circuit board 13 can monitor the working states (such as voltage, current and temperature) of each cell 20 in real time and transmit the data to an external management system via communication interfaces.

In addition, the circuit board 13 may be integrated with a protection circuit, such as over-current protection and short circuit protection, to improve the security of the entire system.

It is to be understood that the positioning plate 12 ensures the accurate positioning of all components in the assembly process, reducing errors and improving the assembly efficiency and quality. The design of the circuit board 13 simplifies the electrical connection, reducing the complexity and time in traditional connection, and provides more reliable connection paths. The integration of a sensor and a controller to the circuit board 13 can realize the real-time monitoring and management of the battery module to detect and address abnormalities and prolong the battery service life. The integrated protection circuit improves the security of the system, and prevents damages or accidents caused by overcurrent, short circuits and other errors. The battery mounting assembly 10 with the positioning plate 12 and the circuit board 13 realizes precise assembly, efficient electrical connection, real-time monitoring and management, and high security, and significantly improves the design and application efficiency of the battery module.

In some embodiments, each positive electrode connecting tab 1131 and/or each negative electrode bracket 112 are arranged with first connecting portions 1114 in a protruding manner in the opposite direction of the third direction z. The circuit board 13 is arranged with a first connecting hole 131 for each first connecting portion 1114. Each first connecting portion 1114 is embedded in the corresponding first connecting hole 131 to ensure close connection of the circuit board 13 to the positive electrode connecting tab 1131 and/or the negative electrode bracket 112, providing a reliable electrical connection.

In some embodiments, each positive electrode bracket 111 and/or each negative electrode bracket 112 are arranged with second connecting portions 1124 in a protruding manner in the opposite direction of the third direction z. The circuit board 13 is arranged with a second connecting hole 132 for each second connecting portion 1124; each second connecting portion 1124 is embedded in the corresponding second connecting hole 132, further enhancing the connection between the circuit board 13 and the parallel-connected bracket 11 and ensuring the reliability and stability of the electrical connection. The design of the first connecting portion 1114 and the second connecting portion 1124 simplifies the electrical connection, reducing the complexity and time in traditional connection, and provides more reliable connection paths.

In some embodiments, the battery mounting assembly 10 also includes a fan mounting bracket 14; the fan mounting bracket 14 is connected to one end of the plurality of the parallel-connected brackets 11 to ensure accurate and stable connection. The fan mounting bracket 14 can be effectively arranged with fans corresponding to the heat dissipation gaps to supply directional airflow to facilitate heat dissipation.

Where, when the plurality of the parallel-connected brackets 11 are arranged with the cells 20, heat dissipation gaps are formed among cells 20 in an extension and communication manner in the second direction x. Such heat dissipation gaps provide circulation paths for cooling air, promoting the heat dissipation.

The heat dissipation fans 30 are mounted on the fan mounting bracket 14 and are corresponding to the positions of the heat dissipation gaps. The heat dissipation fans 30 can accelerate air flow by means of forced convection, effectively dissipate the heat from the cells 20, and keep the operating temperature of the battery module within a safe range.

It is to be understood that the design of the heat dissipation gaps and the heat dissipation fans 30 significantly enhances the heat dissipation performance of the battery module, is conducive to maintaining the proper operating temperature of the cells 20, prolongs their service life, and improves the system efficiency. The heat dissipation gaps extend and connect in the second direction x to ensure effective heat dissipation even in a compact deployment and to make full use of the limited space. A heat dissipation fan 30 can be cleaned or replaced via disconnecting the fan mounting bracket 14. The operation is simple without affecting other components. The heat dissipation fan 30 can be adjusted according to the working environment (such as temperature and humidity) to adapt to different operation conditions. The battery mounting assembly 10 with the fan mounting bracket 14 has efficient heat dissipation performance, significantly improving the design and application efficiency of the battery module.

In some embodiments, the battery mounting assembly 10 also includes a case 15; the case 15 is an outer enclosure structure of the entire battery mounting assembly 10 and provides physical protection and environment isolation. The case 15 is arranged with an accommodating cavity inside to accommodate the plurality of parallel-connected brackets 11 and other components. The plurality of the parallel-connected brackets 11 are arranged in the accommodating cavity and are not higher than a set height in the first direction y to ensure that the overall dimension of the battery module meets the specific requirements. The design is conducive to keeping the compactness of the battery module, meeting the requirements for different installation spaces, and facilitating the transportation and installation.

In some embodiments, the set height may be 37.9 mm, 40 mm or any other reasonable height not greater than 1U. The application imposes no limitation thereon.

It is to be understood that the case 15 provides protection against the external environment, such as dust, water and shock, prolonging the service life of the battery module. The height limitation ensures the compactness of the battery module. Thereby, the battery module can adapt to various installation environments, especially those with limited spaces. The design of the case 15 realizes the integral installation and detachment of the battery module, simplifies the installation process and facilitates the maintenance and replacement. The case 15 may be customized for different application environments. For example, in harsh environments, the case 15 shall have a higher protection grade. The uniform design of the cases 15 ensures that the battery module is more regular and aesthetic and is conducive to realizing the standardized production and reducing the manufacturing costs.

Different from the related art, the parallel-connected bracket of the battery mounting assembly provided in this application includes the positive electrode bracket and the negative electrode bracket which is detachably connected with the positive electrode bracket; the positive electrode bracket is arranged with two rows of the first accommodating holes at intervals facing the negative electrode bracket in the first direction, and the line connecting the center points of two adjacent first accommodating holes in different rows and the first direction form the set included angle which is greater than 0° to form the first air duct in the parallel-connected bracket; the negative electrode bracket is arranged with the second accommodating holes corresponding to the first accommodating holes facing the positive electrode bracket; in the parallel-connected bracket, each first accommodating hole and corresponding second accommodating hole are arranged to set the positive electrode and the negative electrode of a cell. Thereby, in the first direction, i.e., the height direction, different rows of the cells are arranged in a staggered manner with a certain height difference so as to arrange a greater number of cells more compactly within a limited space, thus effectively reducing the overall height of the product. Therefore, the application scope of this product is wider, i.e., electronic devices with limited spatial structure, especially any reasonable electronic device with a standard cabinet unit height of 1U, such as server cabinets, power distribution cabinets, and communication devices. In addition, because the negative electrode bracket is detachable, an individual cell of the battery module can be maintained or replaced more conveniently. The cells are arranged at a certain inclined angle to improve the cooling effect, reduce the mechanical stress, or simplify the manufacturing process. Cells which are not vertically arranged are also conducive to air circulation or heat sink arrangement, thus improving the heat dissipation performance of the entire battery module. The detachable connection design provides the possibility of flexible configuration, enabling adjustment of the number and arrangement mode of cells according to different application requirements.

It should be understood from the several embodiments provided in the application that the battery mounting assembly and the backup power supply may be implemented in other manners. For example, above embodiments of the battery mounting assembly and the backup power supply are merely illustrative. The functional parts are merely divided in a logical manner. Other division manners may be adopted in actual implementation. For example, a plurality of functional parts may be combined or integrated into several modules, or each functional part may exist independently in physical form, and the like.

The above content is only the embodiments in this application and constitutes no limitation to the scope of the patent in this application. Any equivalent structure or equivalent principle transformation made by reference to the specification and the accompany drawings in this application, or direct or indirect application in other related technical fields shall fall within the protection scope of the application.

What is claimed is:

1. A battery mounting assembly, comprising:
one or more parallel-connected brackets, wherein:
the one or more parallel-connected brackets comprises a positive electrode bracket and a negative electrode bracket detachably connected to the positive electrode bracket;
a side of the positive electrode bracket facing the negative electrode bracket is provided with two rows of first accommodating holes spaced apart in a first direction;
a connecting line between center points of two adjacent first accommodating holes in different rows forms a set included angle with the first direction to form a first air duct in the parallel-connected bracket, wherein the set included angle is greater than 0°;
a side of the negative electrode bracket facing the positive electrode bracket is provided with second accommodating holes corresponding to each of the first accommodating holes; and
wherein each of the first accommodating holes in the parallel-connected bracket and its corresponding second accommodating hole are arranged to accommodate a positive electrode and a negative electrode of a cell.

2. The battery mounting assembly according to claim 1, wherein:
a plurality of the parallel-connected brackets are arranged in a second direction;
the positive electrode bracket of a first parallel-connected bracket of two adjacent parallel-connected brackets is detachably connected to the negative electrode bracket of a second parallel-connected bracket of the two adjacent parallel-connected brackets; and
the second direction is perpendicular to the first direction.

3. The battery mounting assembly according to claim 2, wherein:
the positive electrode bracket comprises one or more first buckling portions;
the negative electrode bracket comprises one or more second buckling portions; and
within the same parallel-connected bracket, each of the one or more first buckling portions is engaged with a corresponding one of the one or more second buckling portions to connect the positive electrode bracket to the negative electrode bracket.

4. The battery mounting assembly according to claim 3, wherein:
the positive electrode bracket comprises one of the one or more first buckling portions on each of two opposite sides of the positive electrode bracket in a third direction;
the negative electrode bracket comprises one of the one or more second buckling portions on each of the two opposite sides of the negative electrode bracket in the third direction;
within the same parallel-connected bracket, each of the one or more first buckling portions corresponds to and engages with a corresponding one of the one or more second buckling portions; and
the third direction, the second direction, and the first direction are mutually perpendicular.

5. The battery mounting assembly according to claim 3, wherein:
the positive electrode bracket comprises one or more first positioning protrusions;
the negative electrode bracket comprises one or more first positioning grooves corresponding to the one or more first positioning protrusions; and
when the positive electrode bracket and the negative electrode bracket of the same parallel-connected bracket are connected, one of the one or more first positioning protrusions is inserted into a corresponding one of the one or more first positioning grooves, and one of the one or more second buckling portions passes through the one of the more or more first positioning protrusions to engage with a corresponding one of the one or more first buckling portions.

6. The battery mounting assembly according to claim 3, wherein:
the positive electrode bracket comprises a first positioning portion on each of two opposite sides of the positive electrode bracket in the first direction, each first positioning portion comprising a second positioning protrusion;
the negative electrode bracket comprises a second positioning portion on each of two opposite sides of the negative electrode bracket in the first direction, each second positioning portion comprising a second positioning groove; and
when the positive electrode bracket and the negative electrode bracket of the same parallel-connected bracket are connected, each of the first positioning portion abuts a corresponding second positioning portion, and the second positioning protrusion of the first positioning portion is inserted into the second positioning groove of the corresponding second positioning portion.

7. The battery mounting assembly according to claim 6, wherein:
each of the first positioning portion and each of the second positioning portion comprises a positioning arc surface on each of two sides of the first positioning portion and the second positioning portion in a third direction, the positioning arc surfaces configured to partially wrap around the cell when the cell is installed in the battery mounting assembly; and
the third direction, the second direction, and the first direction are mutually perpendicular.

8. The battery mounting assembly according to claim 1, wherein:
the positive electrode bracket and the negative electrode bracket each comprise a plurality of heat dissipation through-holes;
first heat dissipation through-holes of the positive electrode bracket are located between adjacent first accommodating holes;
second heat dissipation through-holes of the negative electrode bracket are located between adjacent second accommodating holes; and
the first heat dissipation through-holes of the positive electrode bracket and the second heat dissipation through-holes of the negative electrode bracket are connected in a second direction to form a second air duct.

9. The battery mounting assembly according to claim 2, wherein:
the positive electrode bracket comprises one or more clamping grooves;
the negative electrode bracket comprises one or more clamping portions corresponding to the one or more clamping grooves; and
a clamping portion of the negative electrode bracket of the first parallel-connected bracket is locked within a corresponding clamping groove of the positive electrode bracket of the adjacent second parallel-connected bracket to connect the first parallel-connected bracket and the second parallel-connected bracket.

10. The battery mounting assembly according to claim 9, wherein:
the positive electrode bracket comprises one of the one or more clamping grooves on each of two opposite sides of the positive electrode bracket in the second direction;
the negative electrode bracket comprises one of the one or more clamping portions protruding on each of two opposite sides of the negative electrode bracket in the second direction; and
the clamping grooves of the positive electrode bracket of the first parallel-connected bracket correspond to and engage with the clamping portions of the negative electrode bracket of the adjacent second parallel-connected bracket.

11. The battery mounting assembly according to claim 2, wherein the parallel-connected bracket further comprises a battery connector, the battery connector comprising:
a positive electrode connecting tab disposed on a side of the positive electrode bracket facing the negative electrode bracket, the positive electrode connecting tab comprising a plurality of positive electrode connection portions, each positive electrode connection portion corresponding to a respective first accommodating hole and configured to contact the positive electrode of the cell; and
a negative electrode connecting tab disposed on a side of the negative electrode bracket facing the positive electrode bracket, the negative electrode connecting tab comprising a plurality of negative electrode connection portions, each negative electrode connection portion corresponding to a respective second accommodating hole and configured to contact a negative electrode of the cell,
wherein the positive electrode connecting tab is configured to connect positive electrodes of a plurality of cells, and the negative electrode connecting tab is configured to connect negative electrodes of the plurality of cells.

12. The battery mounting assembly according to claim 2, further comprising:
a positioning plate connected to one side of the plurality of the parallel-connected brackets and extending from one end to the other end of the plurality of the parallel-connected brackets in the second direction.

13. The battery mounting assembly according to claim 12, wherein:
at least one of each positive electrode bracket or each negative electrode bracket comprises a positioning buckle protruding in a third direction;
the positioning plate comprises a plurality of positioning holes, each positioning hole corresponding to a respective positioning buckle; and
each positioning buckle is engaged within its corresponding positioning hole,
wherein the third direction, the second direction, and the first direction are mutually perpendicular.

14. The battery mounting assembly according to claim 11, further comprising:
a circuit board connected to one side of the plurality of parallel-connected brackets, the circuit board extending from one end to the other end of the plurality of parallel-connected brackets in the second direction and electrically connected to at least one of each positive electrode connecting tab or each negative electrode connecting tab.

15. The battery mounting assembly according to claim 14, wherein:
at least one of each positive electrode connecting tab or each negative electrode bracket comprises a first connection portion protruding in a direction opposite a third direction;
the circuit board comprises a plurality of first connection holes, each first connection hole corresponding to a respective first connection portion; and
each first connection portion is engaged within its corresponding first connection hole,
wherein the third direction, the second direction, and the first direction are mutually perpendicular.

16. The battery mounting assembly according to claim 2, further comprising:
a fan mounting bracket connected to one end of the plurality of parallel-connected brackets in the second direction,
wherein, when a plurality of cells are installed in the plurality of parallel-connected brackets, a plurality of heat dissipation gaps are formed between the cells, the heat dissipation gaps extending and communicating in the second direction; and
wherein the fan mounting bracket is configured to mount at least one heat dissipation fan through the corresponding heat dissipation gaps.

17. The battery mounting assembly according to claim 2, further comprising:
a case comprising an accommodating cavity;
wherein the plurality of parallel-connected brackets are disposed within the accommodating cavity; and
wherein a height of the plurality of parallel-connected brackets in the first direction is not greater than a predetermined height.

18. A backup power supply, comprising:
a battery mounting assembly; and
a plurality of cells connected to the battery mounting assembly, wherein the battery mounting assembly comprises:
one or more parallel-connected brackets, wherein:
the one or more parallel-connected brackets comprise a positive electrode bracket and a negative electrode bracket detachably connected to the positive electrode bracket;
a side of the positive electrode bracket facing the negative electrode bracket is provided with two rows of first accommodating holes spaced apart in a first direction;
a connecting line between center points of two adjacent first accommodating holes in different rows forms a set included angle with the first direction to form a first air duct in the parallel-connected bracket, wherein the set included angle is greater than 0°; and
a side of the negative electrode bracket facing the positive electrode bracket is provided with second accommodating holes corresponding to each of the first accommodating holes,
wherein each of the first accommodating holes in the parallel-connected bracket and its corresponding second accommodating hole are arranged to accommodate a positive electrode and a negative electrode of a cell.

19. The backup power supply according to claim 18, wherein:
a plurality of the parallel-connected brackets are arranged in a second direction;
the positive electrode bracket of a first parallel-connected bracket of two adjacent parallel-connected brackets is detachably connected to the negative electrode bracket of a second parallel-connected bracket of the two adjacent parallel-connected brackets; and
the second direction is perpendicular to the first direction.

20. The backup power supply according to claim 19, wherein:
the positive electrode bracket comprises one or more first buckling portions;
the negative electrode bracket comprises one or more second buckling portions; and
within the same parallel-connected bracket, each of the one or more first buckling portions is engaged with a corresponding one of the one or more second buckling portions to connect the positive electrode bracket to the negative electrode bracket.
